(19) United States
(12) Patent Application Publication
(10) Pub. No.: US 2006/0282985 A1
(43) Pub. Date: Dec. 21, 2006

(54) Hinge for a notebook computer

(76) Inventors: Sheng-Nan Lu, Shulin City (TW); Tzu-Yu Lin, Shulin City (TW)

Correspondence Address: HERSHKOVITZ & ASSOCIATES, 2845 DUKE STREET, ALEXANDRIA, VA, 22314, US

(21) Appl. No.: 11/375,120

(22) Filed: Mar. 15, 2006

(30) Foreign Application Priority Data
Jun. 21, 2005 (TW) 094210419

(51) Int. Cl. E05D 3/10

(52) U.S. Cl. 16/367

(57) ABSTRACT

A hinge for a notebook computer has a base, a seat, a first ring, a second ring, a positioning ring and a fastener. The base has a hole and a flange. The flange protrudes from the hole. The seat is mounted pivotally in the hole and has a circular tab and a limit. The limit radially extends from the circular tab and selectively abuts the flange to limit the rotating angle of the seat. The first and second rings are mounted between the seat and the base to reduce the friction. The positioning ring is mounted in the hole and has a first boss and a second boss. The fastener is mounted in the hole and has a first notch and a second notch. The first notch and the second notch selectively engage with the second boss and the first boss to position the seat.

### BACKGROUND OF THE INVENTION

1. Field of the Invention

The present invention relates to a hinge for notebook computer, and especially a device for connecting a monitor and a base of notebook computer so a user can turn the monitor about horizontal axis at a raised state.

2. Description of the Related Art

With modern developments in technology, notebook computers become smaller and lighter to be easily carried so the notebook computers are more and more popular. A monitor can be raised at variant angles on a base of a conventional notebook computer. If a user would like to turn the monitor about horizontal axis at a raised status, a conventional hinge needs to be mounted on a body of the notebook computer to rotate the monitor. However, the hinge is too big to reduce the volume of the notebook computer.

In addition, the hinge is made of Zinc alloy. Because Zinc alloy has low hardness, the hinge is easily rubbed so the hinge easily loosens or wears.

### SUMMARY OF THE INVENTION

The objective of the present invention is to provide a hinge for a notebook computer that can reduce the friction of the Zinc alloy and the volume in the notebook computer.

To achieve the foregoing objective, a hinge for a notebook computer has a base, a seat, a first ring, a second ring, a positioning ring and a fastener. The base has a hole and a flange. The flange protrudes from the hole. The seat is mounted pivotally in the hole and has a circular tab and a limit. The limit radially extends from the circular tab and selectively abuts the flange to limit the rotating angle of the seat. The first and second rings are mounted between the seat and the base to reduce the friction. The positioning ring is mounted in the hole and has a first boss and a second boss. The fastener is mounted in the hole and has a first notch and a second notch. The first notch and the second notch selectively engage with the second boss and the first boss to position the seat.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge for a notebook computer in accordance with the present invention;

FIG. 2 is an exploded top perspective view of the hinge for the notebook computer in FIG. 1;

FIG. 3 is an exploded bottom perspective view of the hinge for the notebook computer in FIG. 1;

FIG. 4 is a top view of the hinge for the notebook computer in FIG. 1;

FIG. 5 is a top view of the hinge for the notebook computer after turning an angle of 90 degree in FIG. 1;

FIG. 6 is a bottom view of the hinge for the notebook computer in FIG. 1;

FIG. 7 is a bottom view of the hinge for the notebook computer after turning an angle of 90 degree in FIG. 1;

FIG. 8 is a side view in partial section of the hinge for the notebook computer in FIG. 1; and

FIG. 9 is a perspective view of the hinge in FIG. 1 mounted on the notebook computer.

### DETAILED DESCRIPTION OF THE PREFERRED EMBODIMENTS

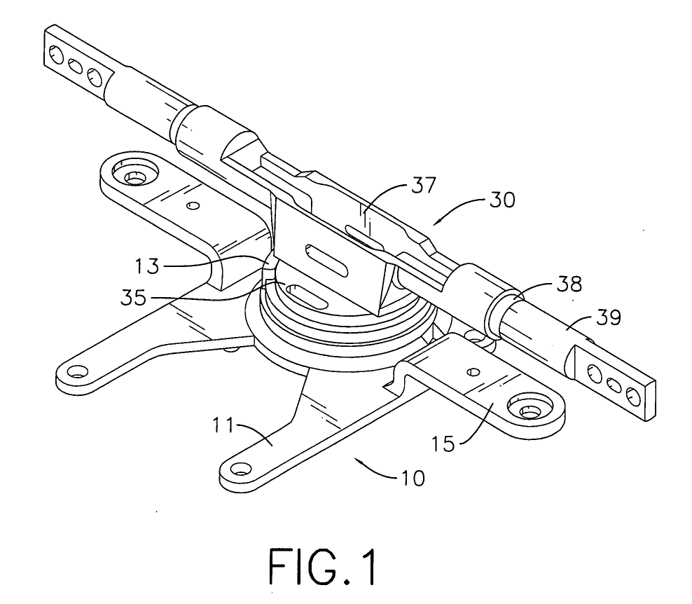

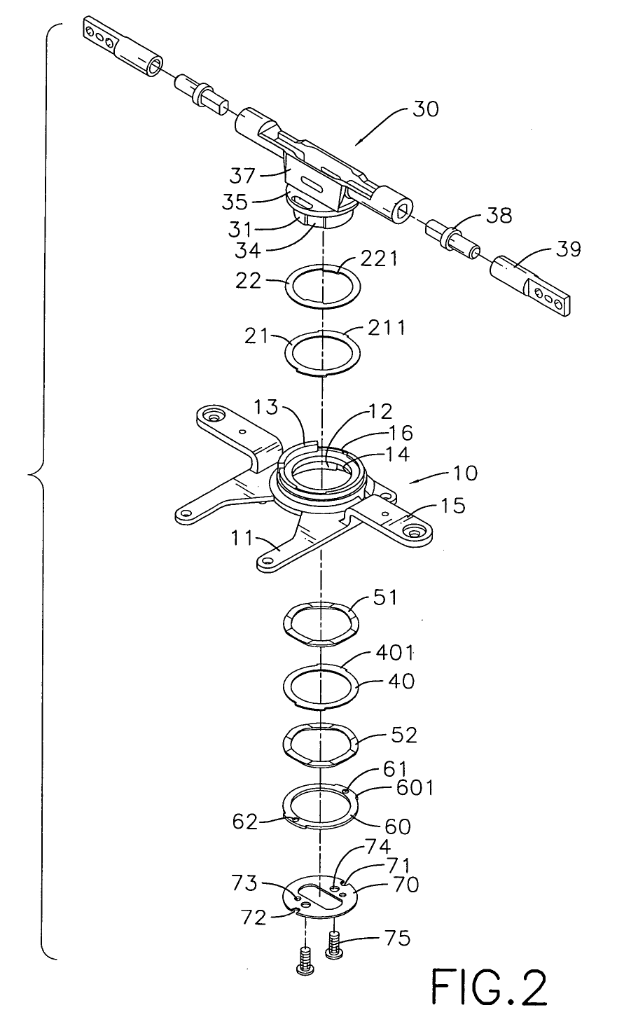

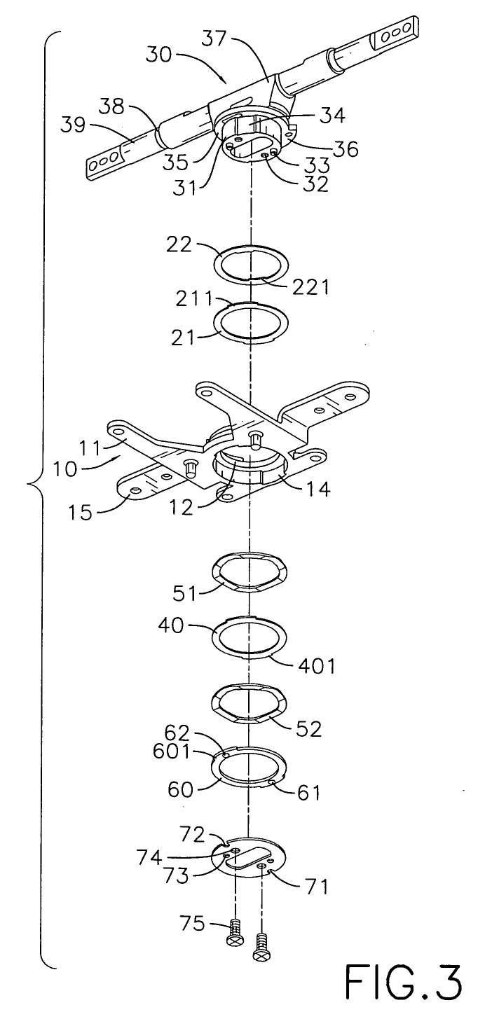

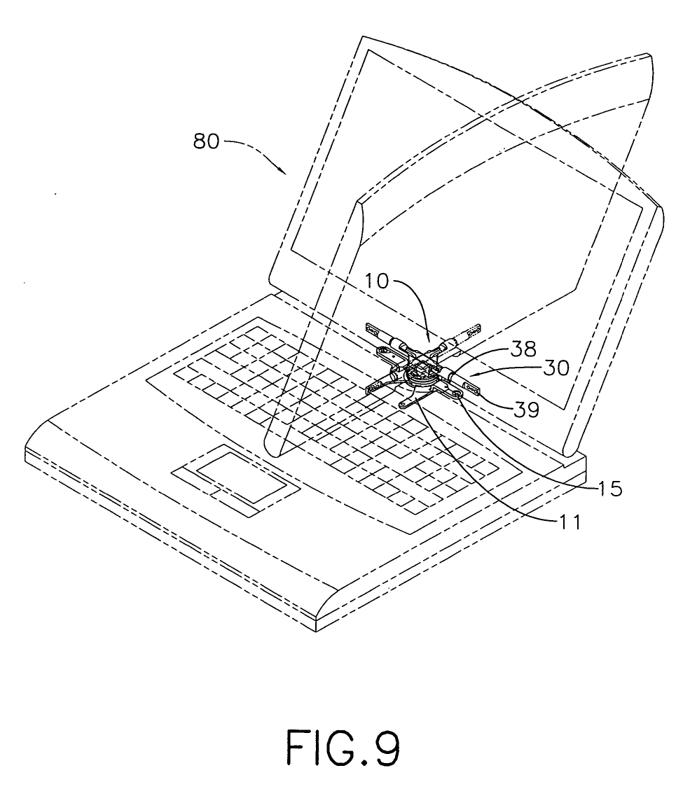

With reference to FIGS. 1 to 3 and 9, a hinge for a notebook computer in accordance with the present invention comprises a base (10), a first ring (21), a second ring (22), a seat (30), an optional washer (40), two optional plane springs (51, 52), a positioning ring (60), a fastener (70) and two screws (75).

The base (10) comprises a center, two optional tab (11), a hole (12), a flange (13), two upper recesses (16), two lower recesses (14), and two optional wings (15). The tabs (11) extend from the base to fasten on a body of a notebook (80). The hole (12) is defined through the center of the base (10) and comprises a top, a bottom and an inner surface. The flange (13) is formed on the top of the hole (12) and comprises two ends. The upper recesses (16) are defined in the inner surface near the top and opposite to each other. The lower recesses (14) are defined in the inner surface near the bottom and opposite to each other. The wings (15) extend from the base and are perpendicular to the tabs (11) to fasten on the body of the notebook computer (80).

The first ring (21) is mounted in the hole (12) and comprises two protrusions (211) and an outer circumference. The protrusions (211) extend from the outer circumference and respectively correspond to and engage the upper recesses (16).

The second ring (22) is mounted in the hole (12) and comprises two protrusions (221) and an inner circumference. The protrusions (221) extend from the inner circumference and are opposite to each other.

The seat (30) is T-shape and comprises a top, a bottom, a pintle (31), two threaded holes (32), two rods (33), two grooves (34), a circular tab (35), a limit (36), an optional rib (37), two optional pivoted elements (38) and two optional fixed tab (39). The pintle (31) is hollow, is formed on the bottom of the seat (30) and comprises a bottom, a top and an outer surface. The threaded holes (32) are formed in the bottom of the pintle (31). The rods (33) are formed on the bottom of the pintle (31). The grooves (34) are defined in the outer surface of the pintle (31) and respectively correspond to and engage the protrusions (221) of the second ring (22). The circular tab (35) is formed on the top of the pintle (31) and comprises a top. The limit (36) radially extends from the circular tab (35) and abuts one end of the flange (13). After rotating an angle of 180 degree, the limit (36) abuts the other end of the flange (13) to be limited. The rib (37) is formed on the top of the circular tab (35). The pivoted elements (38) are mounted securely in the rib (37) and pivot about the horizontal axle to open the notebook computer (80). The fixed tabs (39) are respectively mounted rotatably on the pivoted elements (38) and are fastened on a monitor of the notebook computer (80).

The washer (40) is mounted in the hole (12) and comprises two protrusions (401), a top, a bottom and an outer circumference. The protrusions (401) respectively extend from the outer circumference and correspond to and engage the lower recesses (14).

The plane springs (51, 52) are mounted in the hole (12) and the direction of the resilience is vertical so the seat (30) can stably rotate in relative to the base (10). One of the plane spring (51) is provided on the top of the washer (40). The other one of the plane spring (52) is provided on the bottom of the washer (40).

The positioning ring (60) is mounted in the hole (12) under the plane spring (52) and comprises an outer circumference, two protrusions (601), a first boss (61) and a second boss (62). The protrusions (601) extend from the outer circumference of the positioning ring (60) and comprise a bottom. The first boss (61) and the second boss (62) are respectively formed on the bottom of the protrusions (601).

The fastener (70) is a hollow circular tab, is mounted in the hole (12) under the plane spring (52) and comprises an outer circumference, a first notch (71), a second notch (72), two through holes (73) and two fastening holes (74). The first notch (71) is defined in the outer circumference and selectively engage with the first boss (61) of the positioning ring (60). The second notch (72) is defined in the outer circumference and selectively engage with the second boss (62) of the positioning ring (60). After rotating an angle of 180 degree, the first notch (71) engage with the second boss (62) and the second notch (72) engage with the first boss (61) of the positioning ring (60). The through holes (73) are defined through the fastener (70) and engage with the ribs (33) of the seat (30). The fastening holes (74) are defined through the fastener (70).

The screws (75) is fastened in the threaded hole (32) of the seat (30) through the fastening holes (74) of the fastener (70).

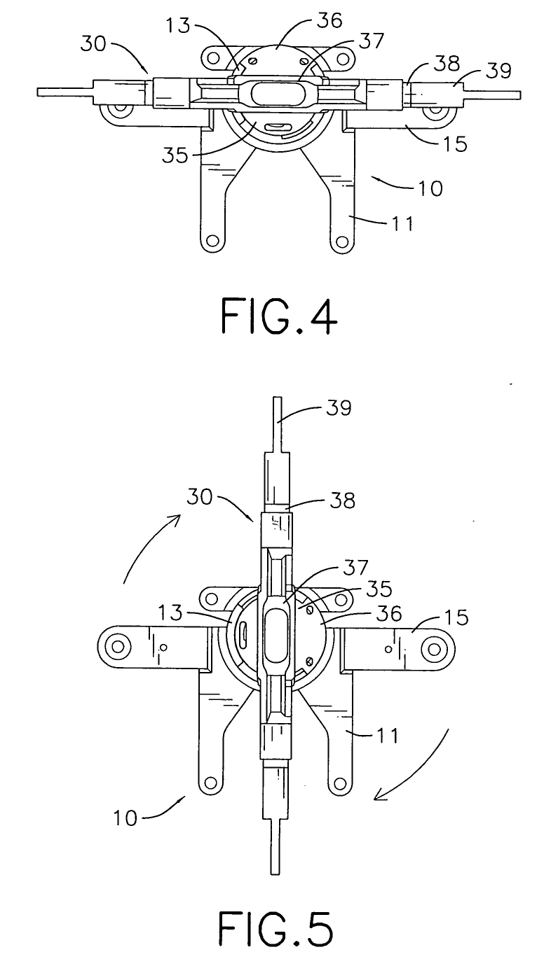

With reference to FIGS. 4 and 5, the limit (36) of the seat (30) selectively abuts the ends of the flange (13) to limit the rotating angle of the seat (30).

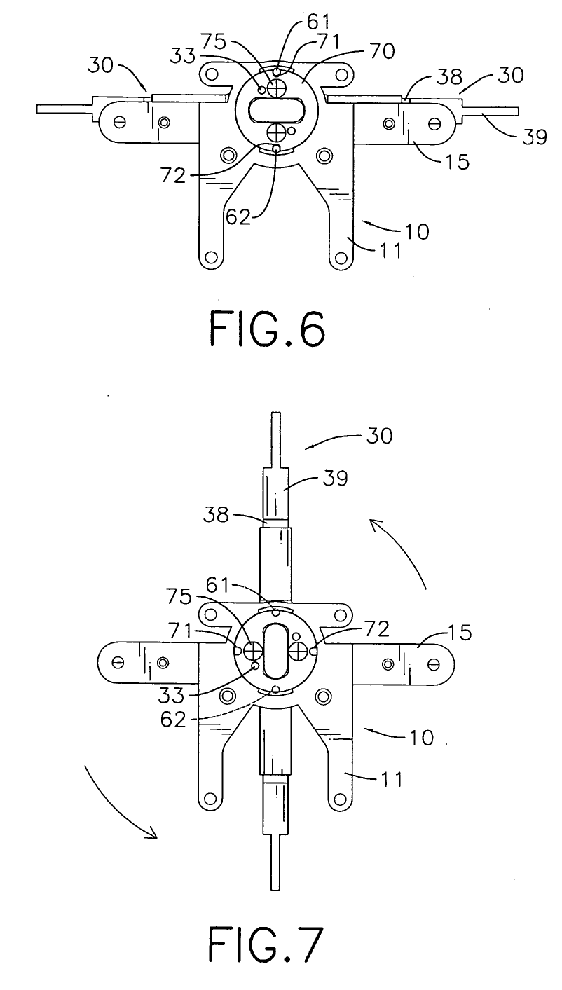

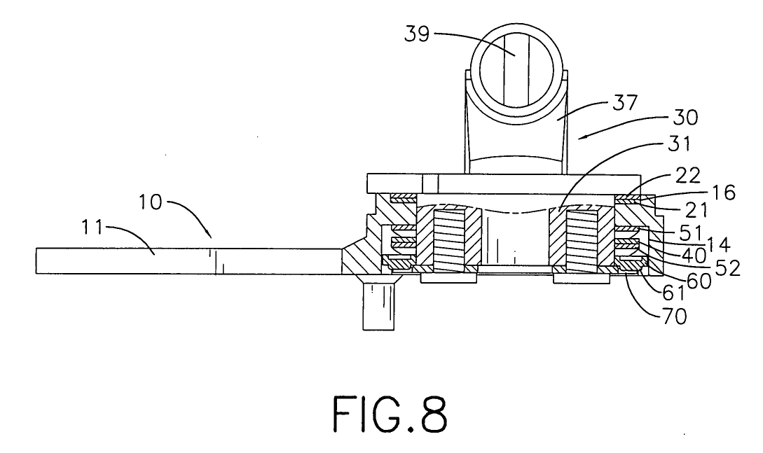

With further reference to FIGS. 6 to 8, the seat (30) and the fastener (70) rotate simultaneously. When the seat (30) rotates, the first notch (71) selectively engage the second boss (62) and the first boss (61) and the second notch (72) selectively engage the first boss (61) and the second boss (62) to position the seat (30).

The first ring (21) and the second ring (22) are mounted between the seat (30) and the base (10) to reduce the friction between the seat (30) and the base (10). Therefore, the hinge for the notebook computer (80) in accordance with the present can reduce the friction of the Zinc alloy and the volume in the notebook computer (80).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge for a notebook computer comprising
a base comprising
a center;
a hole defined through the center of the base and comprising
a top;
a bottom; and
an inner surface;
a flange formed on the top of the hole and comprising
two end;
two upper recesses defined in the inner surface near the top and opposite to each other; and
two lower recesses defined in the inner surface near the bottom and opposite to each other; and
a first ring mounted in the hole and comprising
an outer circumference; and
two protrusions extending from the outer circumference and respectively corresponding to the upper recesses;
a second ring mounted in the hole and comprising
an inner circumference; and
two protrusions extending from the inner circumference and opposite to each other;
a seat being T-shape and comprising
a top;
a bottom;
a pintle being hollow, formed on the bottom of the seat and comprising
a bottom;
a top; and
an outer surface;
two threaded holes formed in the bottom of the pintle;
two rods formed on the bottom of the pintle;
two grooves defined in the outer surface of the pintle and respectively corresponding to and engaging the protrusions of the second ring;
a circular tab formed on the top of the pintle and comprising a top; and
a limit radially extending from the circular tab;
a positioning ring mounted in the hole and comprising
an outer circumference;
two protrusions extending from the outer circumference of the positioning ring and each comprising a bottom;
a first boss and a second boss formed respectively on the bottoms of the protrusions;
a fastener being a hollow circular tab, mounted in the hole and comprising
an outer circumference;
a first notch defined in the outer circumference and selectively engaging with the first boss of the positioning ring;
a second notch defined on the outer circumference and selectively engaging with the second boss of the positioning ring;
two through holes defined through the fastener and selectively engaging with the ribs of the seat; and
two fastening holes defined through the fastener; and
two screws fastened respectively in the threaded holes of the seat through the fastening holes of the fastener.

2. The hinge for the notebook computer as claimed in claim 1, wherein the hinge further comprises
a washer mounted in the hole and comprising
an outer circumference;
two protrusions respectively extending from the outer circumference and corresponding to and engaging the lower recesses;
atop; and
a bottom; and
two plane springs mounted in the hole and respectively provided on the top and the bottom of the washer.

3. The hinge for the notebook computer as claimed in claim 1, wherein the base further comprises
two tabs extending from the base; and
two wings extending from the base and perpendicular to the tabs.

4. The hinge for the notebook computer as claimed in claim 1, wherein the seat further comprises
a rib formed on the top of the circular tab;
two pivoted elements mounted securely in the rib; and
two fixed tab respectively mounted rotatably on the pivoted elements.
